(19) United States
(12) Patent Application Publication
(10) Pub. No.: US 2025/0151100 A1
(43) Pub. Date: May 8, 2025

(54) WIRELESS LOCAL AREA NETWORK SYSTEM USING FREQUENCY HOPPING FOR CO-CHANNEL INTERFERENCE AVOIDANCE

(71) Applicant: Mediatek Inc., Hsinchu City (TW)

(72) Inventors: Kuo-Wei Chen, Hsinchu City (TW); Pochun Fang, Hsinchu City (TW); Kai Ying Lu, San Jose, CA (US)

(73) Assignee: MEDIATEK INC., Hsinchu City (TW)

(21) Appl. No.: 18/936,992

(22) Filed: Nov. 4, 2024

Related U.S. Application Data
(60) Provisional application No. 63/597,318, filed on Nov. 8, 2023.

(51) Int. Cl. H04W 72/541; H04W 84/12

(52) U.S. Cl. CPC H04W 72/541; H04W 84/12

(57) ABSTRACT

A wireless local area network (WLAN) system includes a first Wi-Fi device and at least one second Wi-Fi device. When the first Wi-Fi device and the at least one second Wi-Fi device receive an interference signal that occupies a current operation channel of the first Wi-Fi device and a current operation channel of the at least one second Wi-Fi device, the first Wi-Fi device performs channel switching upon the current operation channel of the first Wi-Fi device, and the at least one second Wi-Fi device performs channel switching upon the current operation channel of the at least one second Wi-Fi device.

### CROSS REFERENCE TO RELATED APPLICATIONS

This application claims the benefit of U.S. Provisional Application No. 63/597,318, filed on Nov. 8, 2023. The content of the application is incorporated herein by reference.

### BACKGROUND

The present invention relates to wireless communications, and more particularly, to a wireless local area network (WLAN) system using frequency hopping for co-channel interference avoidance.

WLANs use radio frequency (RF) signals to communicate between access points (APs) and non-AP stations (STAs). However, these signals can be affected by interference from other signal sources, such as other WLANs or Bluetooth (BT) devices. Interference can degrade the performance, reliability, and security of a WLAN. For example, co-channel interference occurs when two or more APs use the same channel or frequency band within an overlapping coverage area. The co-channel interference causes contention and collisions among client devices that try to access the channel. As a result, the co-channel interference reduces the throughput, increases the latency, and lowers the signal-to-noise ratio (SNR) of a WLAN. From the end user's perspective, it can appear that the WLAN is slow or not operable at all. Thus, there is a need for an innovative co-channel interference avoidance design to improve the WLAN performance.

### SUMMARY

One of the objectives of the claimed invention is to provide a WLAN system using frequency hopping for co-channel interference avoidance. For example, a special frequency hopping operation can improve throughput and/or latency for the WLAN system.

According to a first aspect of the present invention, an exemplary WLAN system is disclosed. The exemplary WLAN system includes a first Wi-Fi device and at least one second Wi-Fi device. When the first Wi-Fi device and the at least one second Wi-Fi device receive an interference signal that occupies a current operation channel of the first Wi-Fi device and a current operation channel of the at least one second Wi-Fi device, the first Wi-Fi device performs channel switching upon the current operation channel of the first Wi-Fi device, and the at least one second Wi-Fi device performs channel switching upon the current operation channel of the at least one second Wi-Fi device.

According to a second aspect of the present invention, an exemplary WLAN system is disclosed. The exemplary WLAN system includes a first Wi-Fi device and at least one second Wi-Fi device. When the first Wi-Fi device and the at least one second Wi-Fi device receive an interference signal that occupies a partial operation channel included in a current operation channel of the first Wi-Fi device and a current operation channel of the at least one second Wi-Fi device, the at least one second Wi-Fi device performs subchannel switching upon the current operation channel of the at least one second Wi-Fi device to switch to a new operation channel which is included in another partial operation channel in the current operation channel of the first Wi-Fi device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a WLAN system that supports the proposed frequency hopping scheme for co-channel interference avoidance according to an embodiment of the present invention.

FIG. 2 is a timing diagram illustrating a frequency hopping scenario with implicit channel switching according to an embodiment of the present invention.

FIG. 3 is a timing diagram illustrating a frequency hopping scenario with implicit channel switching and DL FES according to an embodiment of the present invention.

FIG. 4 is a timing diagram illustrating a frequency hopping scenario with implicit subband switching according to an embodiment of the present invention.

FIG. 5 is a timing diagram illustrating a frequency hopping scenario with implicit subband switching and DL FES according to an embodiment of the present invention.

FIG. 6 is a timing diagram illustrating a frequency hopping scenario with implicit subband switching and UL FES according to an embodiment of the present invention.

FIG. 7 is a timing diagram illustrating a frequency hopping scenario with explicit channel switching and DL FES according to an embodiment of the present invention.

FIG. 8 is a timing diagram illustrating a frequency hopping scenario with explicit channel switching and joint transmission according to an embodiment of the present invention.

FIG. 9 is a timing diagram illustrating a frequency hopping scenario with explicit subband switching and DL FES according to an embodiment of the present invention.

FIG. 10 is a timing diagram illustrating an explicit subband switching FES according to an embodiment of the present invention.

FIG. 11 is a flowchart of AP's dynamic selection mechanism according to an embodiment of the present invention.

FIG. 12 is a timing diagram illustrating AP's 1-1 actions determined by the proposed dynamic selection mechanism according to an embodiment of the present invention.

FIG. 13 is a timing diagram illustrating AP's 2-1 Actions determined by the proposed dynamic selection mechanism according to an embodiment of the present invention.

FIG. 14 is a timing diagram illustrating AP's 2-2 actions determined by the proposed dynamic selection mechanism according to an embodiment of the present invention.

FIG. 15 is a timing diagram illustrating AP's 3-1 actions determined by the proposed dynamic selection mechanism according to an embodiment of the present invention.

FIG. 16 is a timing diagram illustrating AP's 3-2 actions determined by the proposed dynamic selection mechanism according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

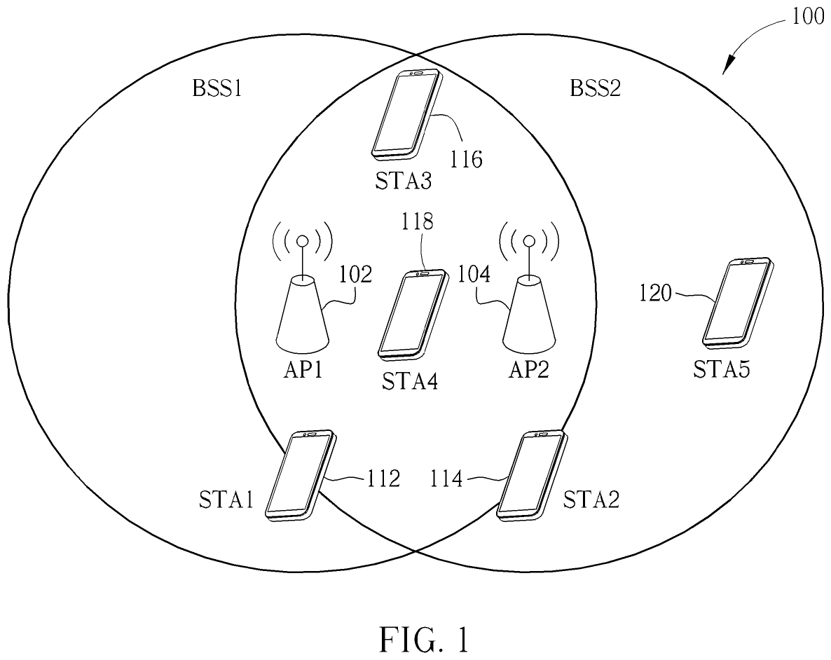

FIG. 1 is a diagram illustrating a WLAN system that supports the proposed frequency hopping scheme for co-channel interference avoidance according to an embodiment of the present invention. The WLAN system 100 may include a plurality of Wi-Fi devices 102, 104, 112, 114, 116, 118, 120. For example, the Wi-Fi devices 102 and 104 may be APs (labeled by “AP1” and “AP2”), and the Wi-Fi devices 112, 114, 116, 118, 120 may be non-AP STAs (labeled by “STA1”, “STA2”, “STA3”, “STA4”, and “STAS”). By way of example, but not limitation, the Wi-Fi devices 102, 104, 112, 114, 116, 118, 120 may be compliant with IEEE 802.11ax (Wi-Fi 6) standard, IEEE 802.11be (Wi-Fi 7) standard, IEEE 802.11bn (Wi-Fi 8) standard, or a later (next-generation) Wi-Fi standard. The non-AP STAs (STA1, STA2, STA3, STA4) are associated to the AP (AP1). The non-AP STA (STA5) is associated to the other AP (AP2). Specifically, the AP (AP1) and the non-AP STAs (STA1, STA2, STA3, STA4) operate in the same basic service set (BSS) (labeled by “BSS1”), and the AP (AP2) and the non-AP STA (STA5) operate in the same BSS (labeled by “BSS2”), where the non-AP STA (STA5) is a hidden node to the AP (AP1). In this embodiment, the AP (AP1) and the non-AP STAs (STA1, STA2, STA3, STA4) may support the proposed frequency hopping scheme for co-channel interference avoidance. It should be noted that the topology of WLAN system 100 shown in FIG. 1 is for illustrative purposes only, and is not meant to be a limitation of the present invention. In practice, the proposed frequency hopping scheme may be employed by any combination of Wi-Fi devices. For example, the proposed frequency hopping scheme may be employed by one AP and N associated non-AP STAs (N≥1) in the same BSS for co-channel interference avoidance.

In some embodiments of the present invention, the APs (AP1, AP2) may be included in the same multi-AP (MAP) system. In an MAP system, several APs form a coordination group. These APs in the same MAP system can serve associated client devices at the same time. Specifically, APs of the same MAP system are able to share transmission resources such as transmission opportunity (TXOP) and target wake time (TWT) service period (SP). For example, APS of the same MAP system can perform joint transmission (JT). Specifically, JT is a technique that leverages the spatial domain and involves non-co-located APs that jointly transmit/receive data to/from multiple non-AP STAs. The proposed frequency hopping scheme may also be employed by any combination of multiple APs in the same MAP system.

The proposed frequency hopping scheme may be an implicit frequency hopping scheme that performs implicit channel switching or implicit subband switching. Alternatively, the proposed frequency hopping scheme may be an explicit frequency hopping scheme that performs explicit channel switching or explicit subband switching. Further details of the proposed frequency hopping scheme are described as below with reference to the accompanying drawings.

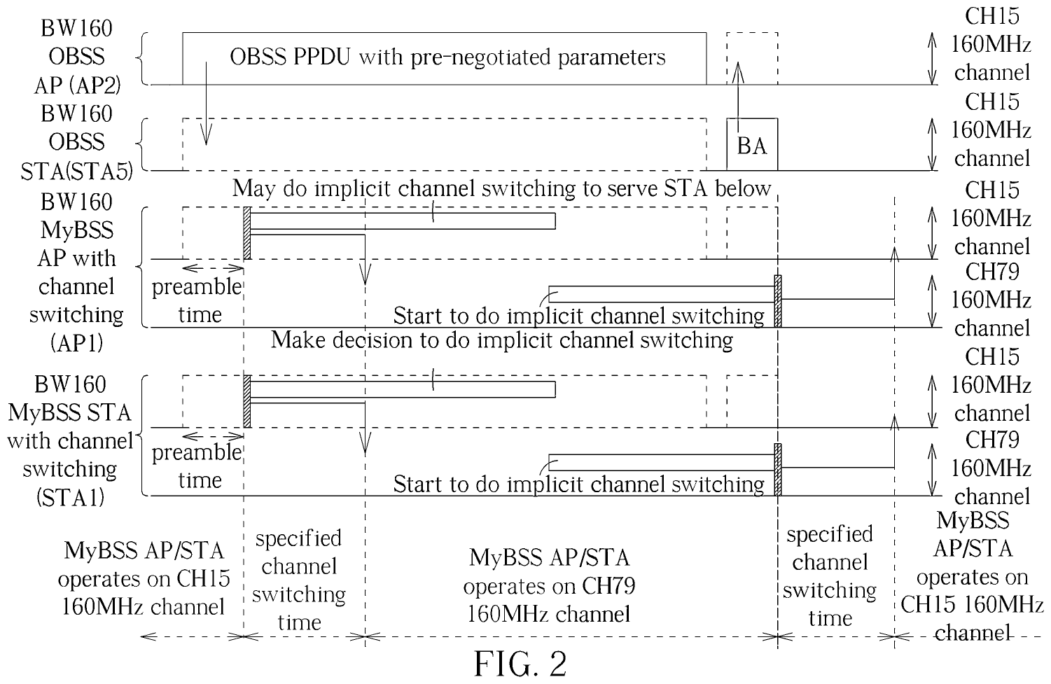

FIG. 2 is a timing diagram illustrating a frequency hopping scenario with implicit channel switching according to an embodiment of the present invention. Suppose that there are one AP (AP1) and one non-AP STA (STA1) in one BSS (BSS1), and there are one AP (AP2) and one non-AP STA (STA5) in another BSS (BSS2). According to BSS coloring, a physical layer protocol data unit (PPDU) sent from AP (AP1) and received by its associated non-AP STA (STA1) is regarded as a MyBSS PPDU, and a PPDU sent from AP (AP2) and received by AP (AP1) and non-AP STA (STA1) is regarded as an overlapping BSS (OBSS) PPDU. In this embodiment, implicit channel switching is decided by OBSS PPDU's information, and the rule is pre-negotiated. That is, before a co-channel interference signal (e.g., OBSS PPDU) is received by two Wi-Fi devices (e.g., AP (AP1) and non-AP STA (STA1) that operate in the same BSS1 (MyBSS)), one or more parameters are pre-negotiated between AP (AP1) and non-AP STA (STA1). For example, the pre-negotiated parameter(s) may include channel switching start time and end time (which may be related to OBSS PPDU start time), BSS color, bandwidth, uplink/downlink (UL/DL), legacy length (L-Length), PPDU type, etc. in HE/EHT format PPDU preamble, medium access control (MAC) information in the MAC header, and/or a specified channel. In addition, the pre-negotiation may be per-BSS based or per-STA based. When AP (AP1) and non-AP STA (STA1) receive an interference signal (e.g., OBSS PPDU) that occupies a current operation channel of AP (AP1) and a current operation channel of non-AP STA (STA1), the AP (AP1) performs channel switching upon its current operation channel, and the non-AP STA (STA1) performs channel switching upon its current operation channel. For example, a new operation channel used by AP (AP1) and non-AP STA (STA1) may be a clean channel with no OBSS interference.

As shown in FIG. 2, both of AP (AP1) and non-AP STA (STA1) support 160 MHz bandwidth (BW), and operate on CH15 160 MHz channel before receiving the OBSS PPDU sent from another AP (AP2). Hence, the current operation channel of AP (AP1) is CH15 160 MHz channel, and the current operation channel of non-AP STA (STA1) is also CH15 160 MHz channel.

The AP (AP2) sends an OBSS PPDU that occupies the current operation channel (CH15 160 MHz channel) of AP (AP1) and the current operation channel (CH15 160 MHz channel) of non-AP STA (STA2). When non-AP STA (STA1) receives the OBSS PPDU that carries pre-negotiated parameter(s), it will perform channel switching to switch to a specified channel (e.g., CH79 160 MHz channel) at one channel switching start time (which may depend on the OBSS PPDU preamble time) and perform another channel switching to switch back to the original operation channel (e.g., CH15 160 MHz channel) at another channel switching start time (which may depend on the OBSS PPDU end time and expected OBSS block acknowledgment (BA) time). Similarly, when AP (AP1) receives the same OBSS PPDU that carries pre-negotiated parameter(s), it knows that non-AP STA (STA1) will switch to the specified channel (e.g., CH79 160 MHz channel), and will perform channel switching to switch to the specified channel (e.g., CH79 160 MHz channel) at one channel switching start time (which may depend on the OBSS PPDU preamble time) and perform another channel switching to switch back to the original operation channel (e.g., CH15 160 MHz channel) at another channel switching start time (which may depend on the OBSS PPDU end time and expected OBSS BA time).

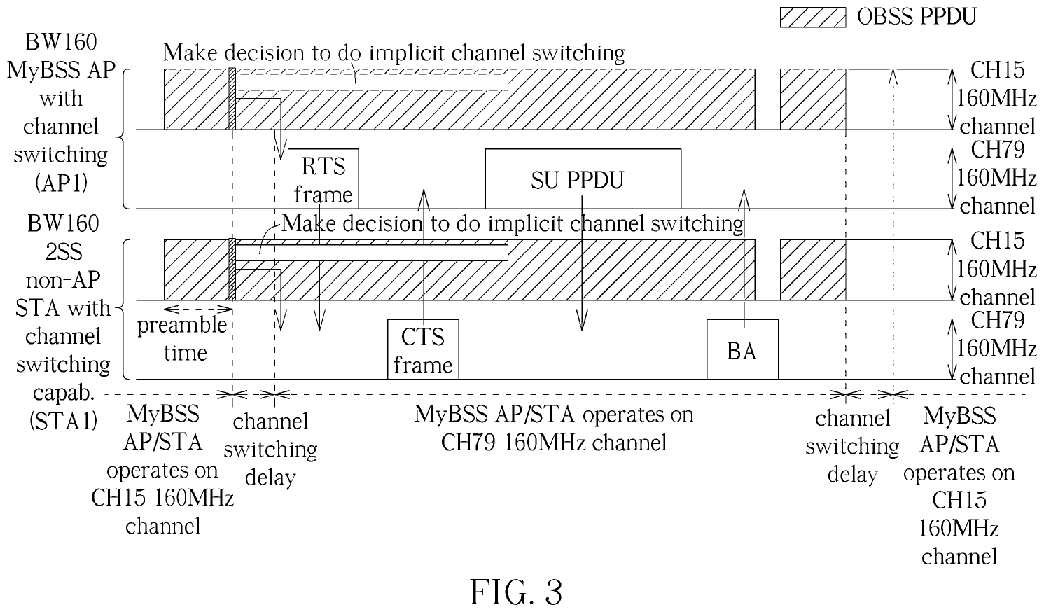

After AP (AP1) and non-AP STA (STA1) perform channel switching to switch to the new operation channel (e.g., CH79 160 MHz channel), a frame exchange sequence (FES) can be initiated for UL/DL traffic. FIG. 3 is a timing diagram illustrating a frequency hopping scenario with implicit channel switching and DL FES according to an embodiment of the present invention. After channel switching is completed, the AP (AP1) operates on the new operation channel (e.g., CH79 160 MHz channel), and sends a request to send (RTS) frame to the non-AP STA (STA1) that also operates on the new operation channel (e.g., CH79 160 MHz channel). In response to the RTS frame sent from the AP (AP1), the non-AP STA (STA1) responds with a clear to send (CTS) frame. After receiving the CTS frame, the AP (AP1) sends a single-user (SU) PPDU to the non-AP STA (STA1). After receiving the SU PPDU, the non-AP STA (STA1) responds with a BA frame.

When the implicit channel switching is performed, the new operation channel assigned to both of AP and associated non-AP STA is not included in the original operation channel of the AP. In some embodiments of the present invention, the proposed frequency hopping scheme may adopt implicit subband switching instead. When the implicit subband switching is performed, the new operation channel assigned to the associated non-AP STA is a subband (also called subchannel) included in the original operation channel of the AP, and the AP does not need to change its operation channel that is currently used. For example, the subband may be a clean subband with no OBSS interference.

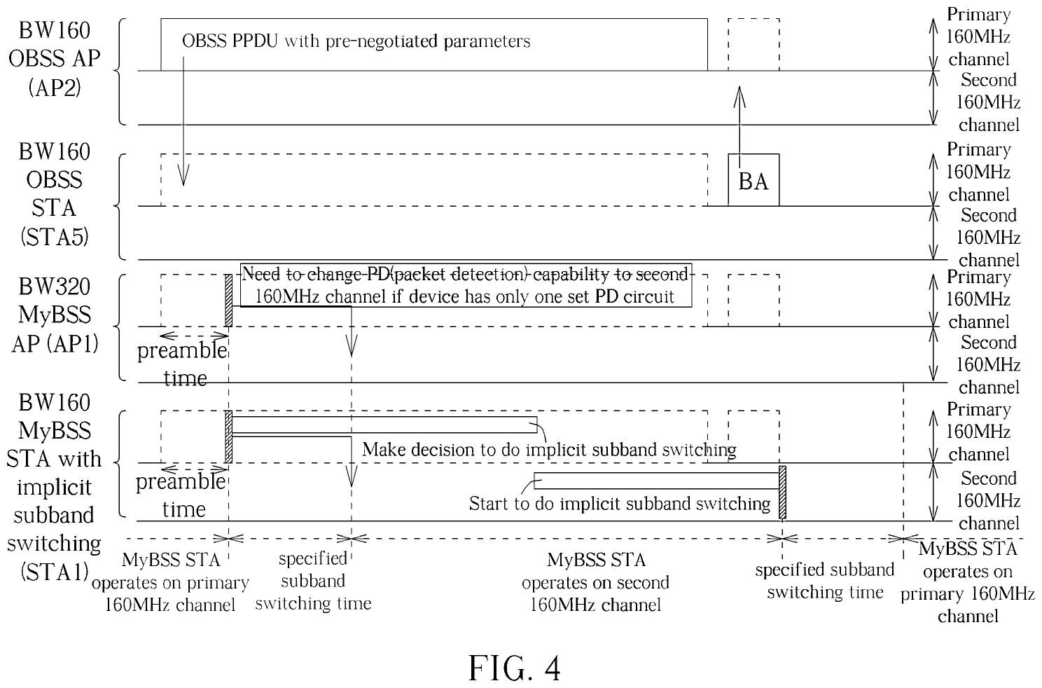

FIG. 4 is a timing diagram illustrating a frequency hopping scenario with implicit subband switching according to an embodiment of the present invention. Suppose that there are one AP (AP1) and one non-AP STA (STA1) in one BSS (BSS1), and there are one AP (AP2) and one non-AP STA (STA5) in another BSS (BSS2). According to BSS coloring, a PPDU sent from AP (AP1) and received by its associated non-AP STA (STA1) is regarded as a MyBSS PPDU, and a PPDU sent from AP (AP2) and received by AP (AP1) and non-AP STA (STA1) is regarded as an OBSS PPDU. Like implicit channel switching, implicit subband switching is also decided by OBSS PPDU's information, and the rule is pre-negotiated. That is, before a co-channel interference signal (e.g., OBSS PPDU) is received by two Wi-Fi devices (e.g., AP (AP1) and non-AP STA (STA1) that operate in the same BSS1 (MyBSS)), one or more parameters are pre-negotiated between AP (AP1) and non-AP STA (STA1). For example, the pre-negotiated parameter(s) may include channel switching start time and end time (which may be related to OBSS PPDU start time), BSS color, bandwidth, UL/DL, L-Length, PPDU type, etc. in HE/EHT format PPDU preamble, MAC information in the MAC header, and/or a specified channel. In addition, the pre-negotiation may be per-BSS based or per-STA based. When AP (AP1) and non-AP STA (STA1) receive an interference signal (e.g., OBSS PPDU) that occupies a partial operation channel included in a current operation channel of AP (AP1) and a current operation channel of non-AP STA (STA1), the non-AP STA (STA1) performs subband switching upon its current operation channel.

As shown in FIG. 4, the AP (AP1) supports 320 MHz BW and operates on an operation channel (which consists of a primary 160 MHz channel and a secondary 160 MHz channel) before receiving the OBSS PPDU sent from another AP (AP2); and the non-AP STA (STA1) supports 160 MHz BW, and operates on the primary 160 MHz channel before receiving the OBSS PPDU sent from another AP (AP2). Hence, the current operation channel of AP (AP1) is a 320 MHz channel, and the current operation channel of non-AP STA (STA1) is a partial operation channel (e.g., primary 160 MHz channel) included in the current operation channel of AP (AP1).

The AP (AP2) sends an OBSS PPDU that occupies the partial operation channel (e.g., primary 160 MHz channel) included in the current operation channel of AP (AP1) and also occupies the current operation channel (e.g., primary 160 MHz channel) of non-AP STA (STA2). When non-AP STA (STA1) receives the OBSS PPDU that carries pre-negotiated parameter(s), it will perform subband switching to switch to a specified channel (e.g., secondary 160 MHz channel) at one subchannel switching start time (which may depend on the OBSS PPDU preamble time), and perform another subband switching to switch back to the original operation channel (e.g., primary 160 MHz channel) at another subband switching start time (which may depend on the OBSS PPDU end time and expected OBSS BA time). Since AP (AP1) operates on a 320BW operation channel that includes the specified channel (e.g., secondary 160 MHz channel) to which the non-AP STA (STA1) switches, the AP (AP1) keeps operating on the current operation channel. In this embodiment, when the AP (AP1) receives the same OBSS PPDU that carries pre-negotiated parameter(s), it knows that non-AP STA (STA1) will switch to the specified channel (e.g., secondary 160 MHz channel), and may need to change its packet detection (PD) capability to the specified channel (e.g., secondary 160 MHz channel) if it has only one PD circuit. As shown in FIG. 4, the AP (AP1) will switch its PD capability to the secondary 160 MHz channel after the start of an OBSS PPDU (which is an OBSS PPDU with pre-negotiated parameter(s)), and will switch its PD capability back to the primary 160 MHz channel after the end of the OBSS PPDU.

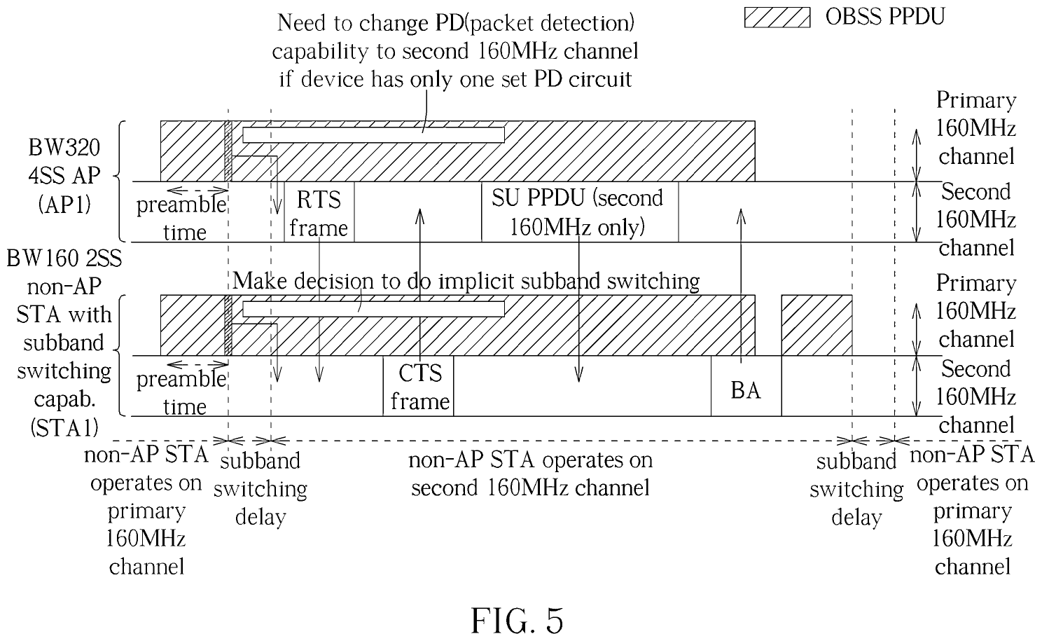

After non-AP STA (STA1) performs subband switching to switch to the new operation channel (e.g., secondary 160 MHz channel), an FES can be initiated for UL/DL traffic. FIG. 5 is a timing diagram illustrating a frequency hopping scenario with implicit subband switching and DL FES according to an embodiment of the present invention. The AP (AP1) operates on the BW320 operation channel, and may change its PD capability to the secondary 160 MHz channel. Hence, the AP (AP1) sends an RTS frame on the secondary 160 MHz channel. In response to the RTS frame sent from the AP (AP1), the non-AP STA (STA1) responds with a CTS frame on the secondary 160 MHz channel. After receiving the CTS frame, the AP (AP1) sends an SU PPDU on the secondary 160 MHz channel. After receiving the SU PPDU, the non-AP STA (STA1) responds with a BA frame on the secondary 160 MHz channel.

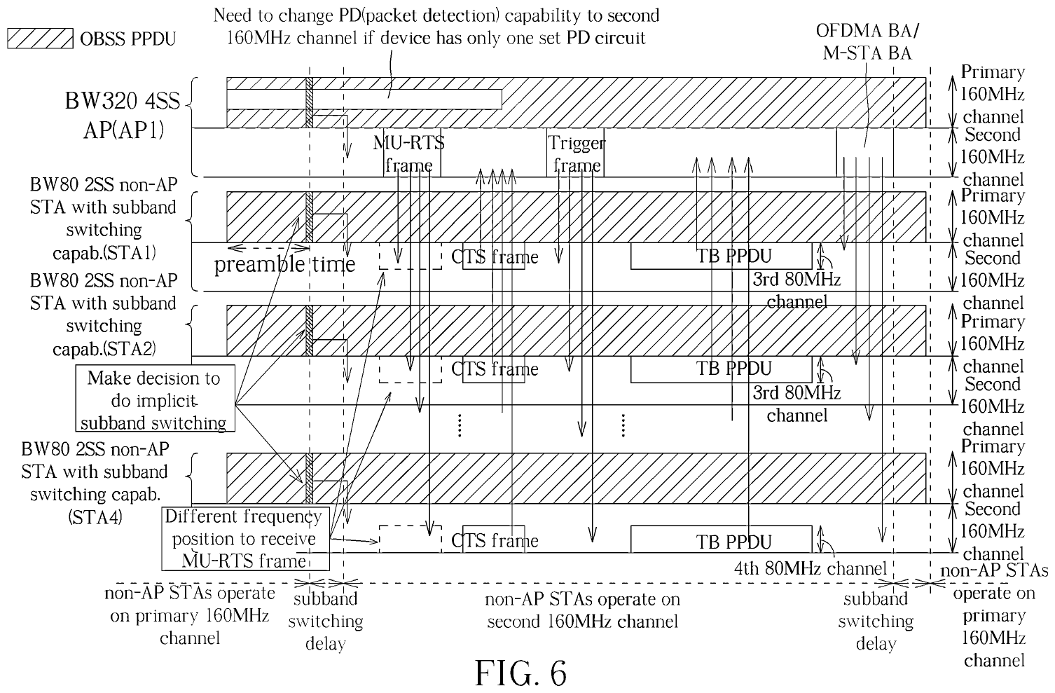

FIG. 6 is a timing diagram illustrating a frequency hopping scenario with implicit subband switching and UL FES according to an embodiment of the present invention. Suppose that there are one AP (AP1) and four non-AP STAs (STA1, STA2, STA3, STA4) in one BSS (BSS1), and there are one AP (AP2) and one non-AP STA (STA5) in another BSS (BSS2). According to BSS coloring, a PPDU sent from AP (AP1) and received by its associated non-AP STAs (STA1, STA2, STA3, STA4) is regarded as a MyBSS PPDU, and a PPDU sent from AP (AP2) and received by AP (AP1) and non-AP STAs (STA1, STA2, STA3, STA4) is regarded as an OBSS PPDU. In this embodiment, the AP (AP2) sends an OBSS PPDU that occupies a partial operation channel (e.g., primary 160 MHz channel) included in the current operation channel of AP (AP1) and also occupies current operation channels (e.g., 1^{st} 80 MHz channel in the primary 160 MHz channel) of non-AP STAs (STA1, STA2, STA3, STA4).

When the non-AP STA (STA1) receives the OBSS PPDU that carries pre-negotiated parameter(s), it will perform subband switching to switch to a specified channel (e.g., 3^{rd} 80 MHz channel included in the secondary 160 MHz channel) at one subchannel switching start time (which may depend on the OBSS PPDU preamble time), and perform another subband switching to switch back to the original operation channel (e.g., 1^{st} 80 MHz channel included in the secondary 160 MHz channel) at another subband switching start time (which may depend on the OBSS PPDU end time and expected OBSS BA time). When non-AP STA (STA2) receives the OBSS PPDU that carries pre-negotiated parameter(s), it will perform subband switching to switch to a specified channel (e.g., 3^{rd} 80 MHz channel included in the secondary 160 MHz channel) at one subchannel switching start time (which may depend on the OBSS PPDU preamble time), and perform another subband switching to switch back to the original operation channel (e.g., 1^{st} 80 MHz channel included in the primary 160 MHz channel) at another subband switching start time (which may depend on the OBSS PPDU end time and expected OBSS BA time). When non-AP STA (STA4) receives the OBSS PPDU that carries pre-negotiated parameter(s), it will perform subband switching to switch to a specified channel (e.g., 4^{th} 80 MHz channel included in the secondary 160 MHz channel) at one subchannel switching start time (which may depend on the OBSS PPDU preamble time), and perform another subband switching to switch back to the original operation channel (e.g., 1^{st} 80 MHz channel included in the primary 160 MHz channel) at another subband switching start time (which may depend on the OBSS PPDU end time and expected OBSS BA time).

The AP (AP1) operates on the BW320 operation channel, and may change its PD capability to the secondary 160 MHz channel after receiving the OBSS PPDU. The AP (AP1) sends a multi-user RTS (MU-RTS) frame on the secondary 160 MHz channel. In response to the MU-RTS frame sent from the AP (AP1), each of the non-AP STAs (STA1, STA2, STA3, STA4) responds with a CTS frame on its operation channel (e.g., 3^{rd}80 MHz channel or 4^{th} 80 MHz channel included in the secondary 160 MHz channel). After receiving the CTS frames, the AP (AP1) sends a trigger frame on the secondary 160 MHz channel. After receiving the trigger frame, each of the non-AP STAs (STA1, STA2, STA3, STA4) sends a trigger-based (TB) PPDU on its operation channel (e.g., 3^{rd} 80 MHz channel or 4^{th} 80 MHz channel included in the secondary 160 MHz channel). After receiving TB PPDUs from the non-AP STAs (STA1, STA2, STA3, STA4), the AP (AP1) responds with an orthogonal frequency division multiple access (OFDMA) BA frame or a multi-station (M-STA) BA frame.

The implicit channel/subband switching is performed under a condition that no notification frame or control frame is explicitly sent from an AP to its associated non-AP STA(s). In some embodiments of the present invention, the proposed frequency hopping scheme may adopt explicit channel/subband switching for co-channel interference avoidance. Specifically, if an SNR of a receiver of a non-AP STA that operates on an operation channel occupied by co-channel interference is still high enough for notification frame reception, the explicit channel/subband switching approach may be adopted.

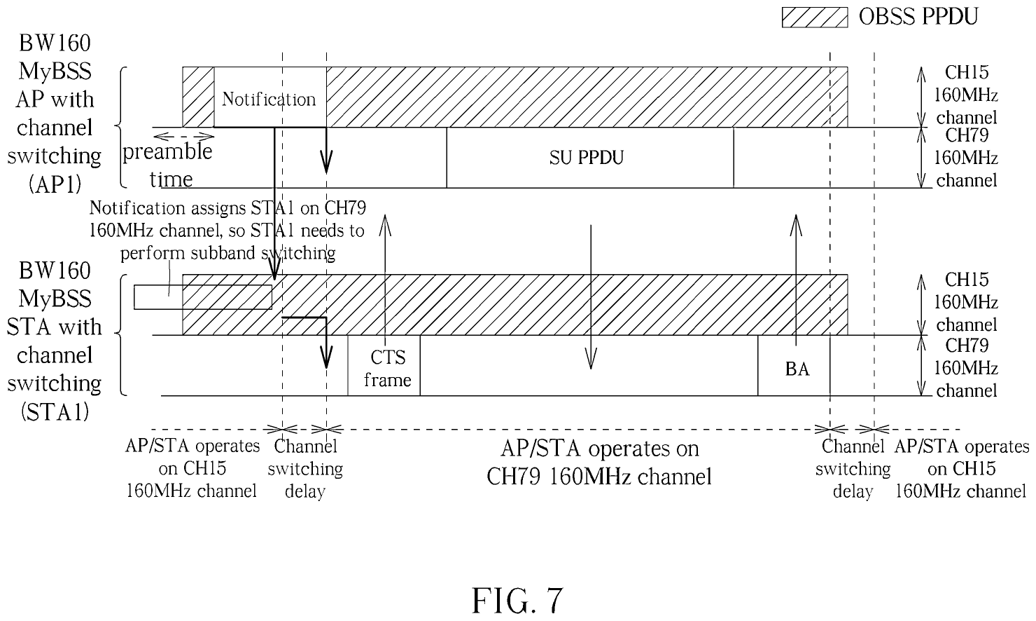

FIG. 7 is a timing diagram illustrating a frequency hopping scenario with explicit channel switching and DL FES according to an embodiment of the present invention. Suppose that there are one AP (AP1) and one non-AP STA (STA1) in one BSS (BSS1), and there are one AP (AP2) and one non-AP STA (STA5) in another BSS (BSS2). According to BSS coloring, a PPDU sent from AP (AP1) and received by its associated non-AP STA (STA1) is regarded as a MyBSS PPDU, and a PPDU sent from AP (AP2) and received by AP (AP1) and non-AP STA (STA1) is regarded as an OBSS PPDU. As shown in FIG. 7, both of AP (AP1) and non-AP STA (STA1) support 160 MHz BW, and operate on CH15 160 MHz channel before receiving the OBSS PPDU sent from another AP (AP2). Hence, the current operation channel of AP (AP1) is CH15 160 MHz channel, and the current operation channel of non-AP STA (STA1) is also CH15 160 MHz channel.

The AP (AP2) sends an OBSS PPDU that occupies the current operation channel (CH15 160 MHz channel) of AP (AP1) and the current operation channel (CH15 160 MHz channel) of non-AP STA (STA2). When AP (AP1) receives the OBSS PPDU, it will send a notification frame (e.g., an RTS frame) to the non-AP STA (STA1), and will perform channel switching to switch to a specified channel (e.g., CH79 160 MHz channel) at one channel switching start time, and perform another channel switching to switch back to the original operation channel (e.g., CH15 160 MHz channel) at another channel switching start time. In response to the notification frame (e.g., RTS frame) sent from the AP (AP1), the non-AP STA (STA1) will perform channel switching to switch to the specified channel (e.g., CH79 160 MHz channel), and perform another channel switching to switch back to the original operation channel (e.g., CH15 160 MHz channel) at another channel switching start time.

After AP (AP1) and non-AP STA (STA1) perform channel switching to switch to the new operation channel (e.g., CH79 160 MHz channel), an FES can be initiated for UL/DL traffic. As shown in FIG. 7, the non-AP STA (STA1) operates on the new operation channel (e.g., CH79 160 MHz channel), and sends a CTS frame to the AP (AP1). After receiving the CTS frame, the AP (AP1) sends an SU PPDU to the non-AP STA (STA1). After receiving the SU PPDU, the non-AP STA (STA1) responds with a BA frame.

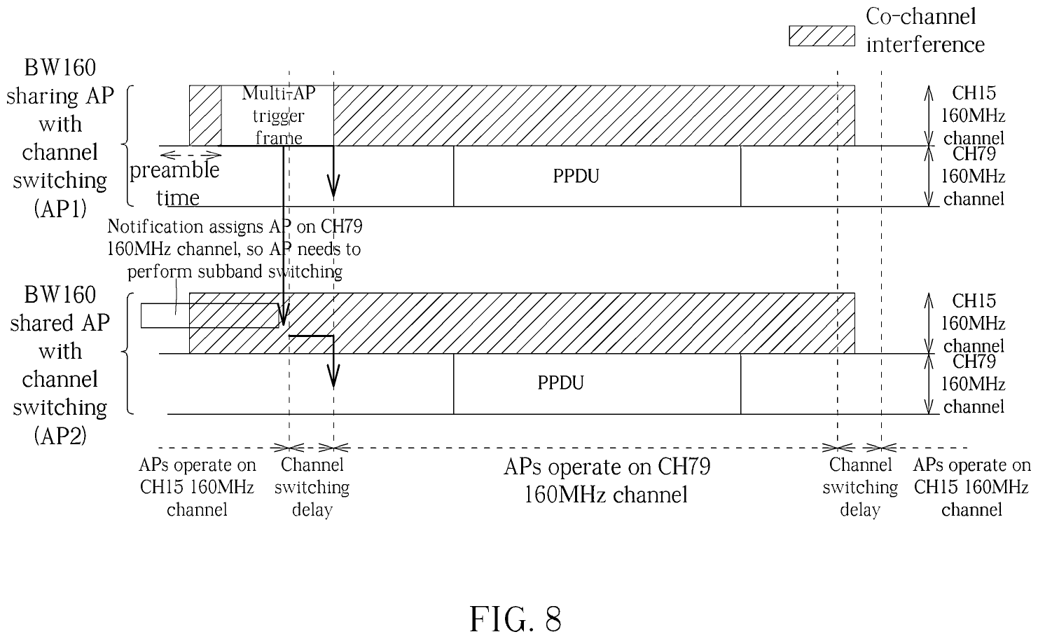

In some embodiments of the present invention, the same explicit channel switching approach for co-channel interference avoidance may be employed by multiple APs (particularly, sharing AP and shared AP (s)) in the same MAP system. FIG. 8 is a timing diagram illustrating a frequency hopping scenario with explicit channel switching and joint transmission according to an embodiment of the present invention. Suppose that AP (AP1) and AP (AP2) are in the same MAP system, where AP (AP1) may be a sharing AP that shares its resource (e.g., TXOP) with other AP(s) in the same MAP system, and AP (AP2) may be a shared AP that participates in resource sharing offered by the sharing AP. As shown in FIG. 8, both of AP (AP1) and non-AP STA (STA1) support 160 MHz BW, and operate on the CH15 160 MHz channel before receiving a co-channel interference signal. Hence, the current operation channel of the sharing AP (AP1) is CH15 160 MHz channel, and the current operation channel of the shared AP (AP2) is also CH15 160 MHz channel.

When the sharing AP (AP1) receives the co-channel interference signal, it will send a notification frame (e.g., a multi-AP trigger frame) to the shared AP (AP2), and will perform channel switching to switch to a specified channel (e.g., CH79 160 MHz channel) at one channel switching start time, and perform another channel switching to switch back to the original operation channel (e.g., CH15 160 MHz channel) at another channel switching start time. In response to the notification frame (e.g., multi-AP trigger frame) sent from the sharing AP (AP1), the shared AP (AP2) will perform channel switching to switch to the same specified channel (e.g., CH79 160 MHz channel), and perform another channel switching to switch back to the original operation channel (e.g., CH15 160 MHz channel) at another channel switching start time. In addition, after sharing AP (AP1) and shared AP (AP2) perform channel switching to switch to the new operation channel (e.g., CH79 160 MHz channel), joint transmission can be initiated on the new operation channel (e.g., CH79 160 MHz channel).

When the explicit channel switching is performed, the new operation channel assigned to both of AP and associated non-AP STA is not included in the original operation channel of the AP. In some embodiments of the present invention, the proposed frequency hopping scheme may adopt explicit subband switching instead. When the explicit subband switching is performed, the new operation channel assigned to the associated non-AP STA is included in the original operation channel of the AP, and the AP does not need to change its operation channel that is currently used.

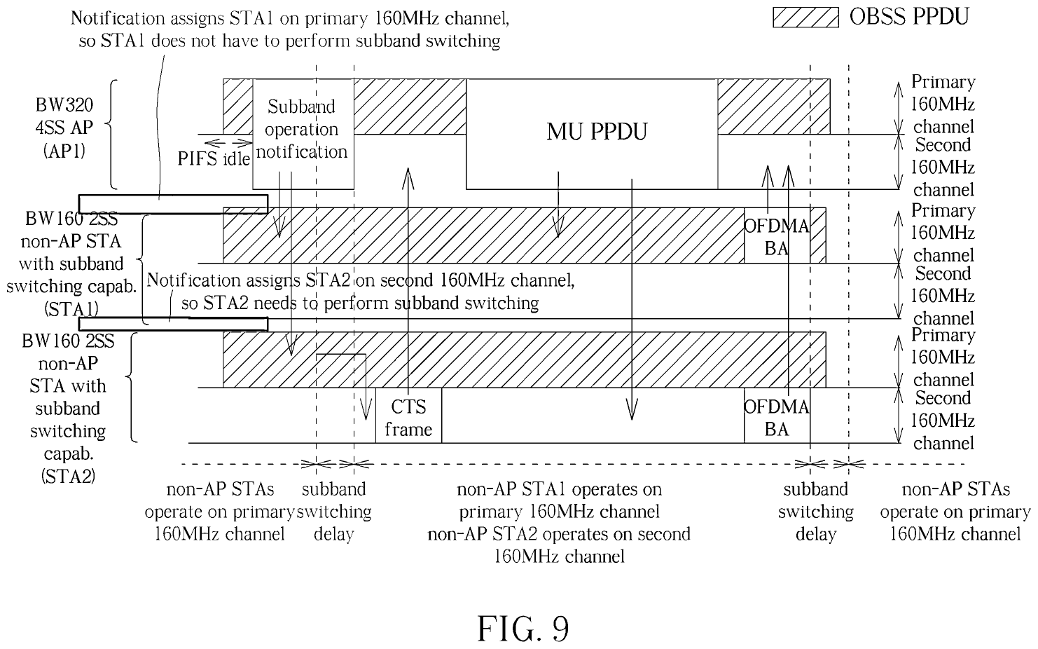

FIG. 9 is a timing diagram illustrating a frequency hopping scenario with explicit subband switching and DL FES according to an embodiment of the present invention. Suppose that there are one AP (AP1) and two non-AP STAs (STA1, STA2) in one BSS (BSS1), and there are one AP (AP2) and one non-AP STA (STA5) in another BSS (BSS2). According to BSS coloring, a PPDU sent from AP (AP1) and received by its associated non-AP STAs (STA1, STA2) is regarded as a MyBSS PPDU, and a PPDU sent from AP (AP2) and received by AP (AP1) and non-AP STAs (STA1, STA2) is regarded as an OBSS PPDU. Like explicit channel switching, explicit subband switching is initiated by a notification frame such as a subband operation notification frame. As shown in FIG. 9, the AP (AP1) supports 320 MHz BW and operates on an operation channel (which consists of a primary 160 MHz channel and a secondary 160 MHz channel) before receiving the OBSS PPDU sent from another AP (AP2); and each of non-AP STAs (STA1 and STA2) supports 160 MHz BW, and operates on the primary 160 MHz channel before receiving the OBSS PPDU sent from another AP (AP2). Hence, the current operation channel of AP (AP1) is a 320 MHz channel, and the current operation channel of each non-AP STA (STA1, STA2) is a partial operation channel (e.g., primary 160 MHz channel) included in the current operation channel of AP (AP1).

The AP (AP2) sends an OBSS PPDU that occupies a partial operation channel (e.g., primary 160 MHz channel) included in the current operation channel of AP (AP1) and also occupies the current operation channel (e.g., primary 160 MHz channel) of each non-AP STA (STA1, STA2). When AP (AP1) receives the OBSS PPDU, it will send a subband operation notification frame (e.g., an MU-RTS frame) to the non-AP STAs (STA1, STA2).

In this embodiment, the subband operation notification frame (e.g., MU-RTS frame) may indicate that the non-AP STA (STA1) does not need to perform subband switching, and the non-AP STA (STA2) needs to perform subband switching. Hence, in response to the subband operation notification frame (e.g., MU-RTS frame) sent from the AP (AP1), the non-AP STA (STA1) keeps operating on the current operation channel (e.g., primary 160 MHz channel), and the other non-AP STA (STA2) will perform subband switching to switch to the specified channel (e.g., secondary 160 MHz channel) at one subchannel switching start time, and perform another subband switching to switch back to the original operation channel (e.g., primary 160 MHz channel) at another subband switching start time.

After non-AP STA (STA2) performs subband switching to switch to the new operation channel (e.g., secondary 160 MHz channel), an FES can be initiated for UL/DL traffic. The AP (AP1) operates on the BW320 operation channel, and receives a CTS frame from the non-AP STA (STA2) on the secondary 160 MHz channel. Next, the AP (AP1) sends an MU PPDU on the 320 MHz operation channel. After receiving the MU PPDU, the non-AP STA (STA1) responds with an OFDMA BA frame on the primary 160 MHz channel. After receiving the MU PPDU, the non-AP STA (STA2) responds with an OFDMA BA frame on the secondary 160 MHz channel.

Regarding the embodiment shown in FIG. 9, a response frame (e.g., CTS frame) generated in response to the subband operation notification frame (e.g., MU-RTS frame) is sent on the new operation channel (e.g., secondary 160 MHz channel) only. Specifically, regarding the subband operation notification frame (e.g., MU-RTS frame), a non-AP STA (STA2) instructed to do subband switching will respond with a CTS frame on the secondary 160 MHz channel only, while a non-AP STA instructed to stay on the primary 160 MHz channel will not respond with a CTS frame on the primary 160 MHz channel due to the fact that its network allocation vector (NAV) is not necessarily a zero value at this moment.

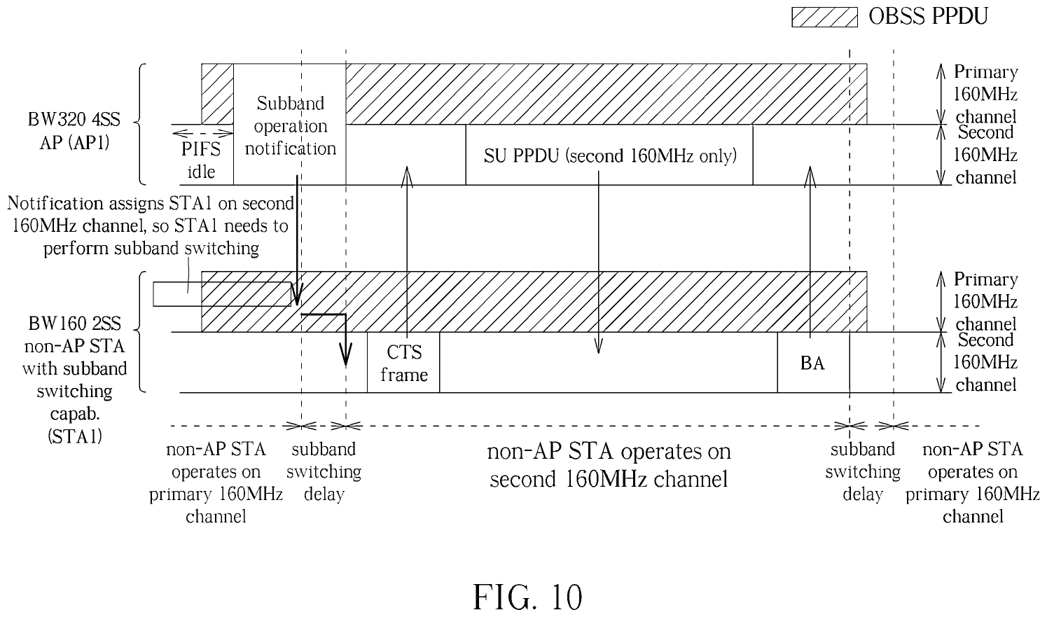

In some embodiments of the present invention, a subband operation notification frame sent from an AP may instruct each non-AP STA interfered with a co-channel interference signal (e.g., OBSS PPDU) to perform subband switching for co-channel interference avoidance (e.g., secondary channel only subband operation during interference on primary channel). Regarding the secondary channel only subband operation during interference on the primary channel, there are two FES types. One is implicit subband switching FES, as illustrated in FIG. 4. The other is explicit subband switching FES, as illustrated in FIG. 10.

In some embodiments of the present invention, the AP may provide negotiation suggestion to its associated non-AP STA(s) for different topologies. Specifically, since there are various situations determined based on capabilities of the associated non-AP STAs and only the AP has a global view, the AP may provide negotiation suggestion to its associated non-AP STAs to avoid unnecessary switching actions of the non-AP STAs. In this way, the Wi-Fi system can achieve better throughput performance and latency performance. For example, when the proposed frequency hopping scheme employs implicit/explicit channel switching, an AP (e.g., AP1) provides negotiation suggestion to a non-AP STA (e.g., one of STA1, STA2, STA3, and STA4), for suggesting actions of the channel switching performed upon the current operation channel of the non-AP STA. For another example, when the proposed frequency hopping scheme employs implicit/explicit subband switching, an AP (e.g., AP1) provides negotiation suggestion to a non-AP STA (e.g., one of STA1, STA2, STA3, and STA4), for suggesting actions of the subband switching performed upon the current operation channel of the non-AP STA. Taking a BW320 AP (e.g., AP1) for example, AP's negotiation suggestions provided to three BW80 non-AP STAs (e.g., STA1, STA2, and STA3) may include switching to the second 80 MHz channel for STA1, switching to the third 80 MHz channel for STA2, and switching to the fourth 80 MHz channel for STA3. However, this is for illustrative purposes only, and is not meant to be a limitation of the present invention.

In some embodiments of the present invention, when co-channel interference occurs and affects an AP (e.g., AP1) and its associated non-AP STAs (e.g., STA1, STA2, STA3, STA4), the AP may check a status of a current operation channel of each non-AP STA to determine its actions (e.g., FES actions). For example, if an SNR of a receiver of a non-AP STA that operates on an operation channel occupied by co-channel interference is still high enough for UL/DL frame exchange, the non-AP STA may stay on the current operation channel without subband switching. For another example, if an SNR of a receiver of a non-AP STA that operates on an operation channel occupied by co-channel interference is not high enough for UL/DL frame exchange, the non-AP STA may do subband switching to switch to a clean channel for UL/DL frame exchange.

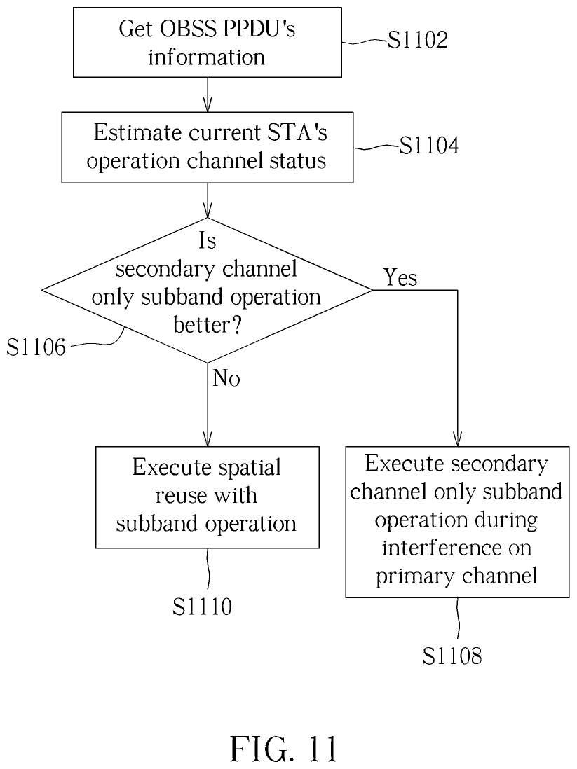

FIG. 11 is a flowchart of AP's dynamic selection mechanism according to an embodiment of the present invention. At step S1102, an AP (e.g., AP1) receives an OBSS PPDU, and identifies the OBSS PPDU as a co-channel interference signal due to the fact that the OBSS PPDU occupies at least a portion (i.e., part or all) of the current operation channel of the AP (e.g., AP1) and also occupies the current operation channel of at least one non-AP STA (e.g., STA1, STA2, STA3, and/or STA4) associated to the AP (e.g., AP1). The AP (e.g., AP1) may also check OBSS PPDU's information to determine whether the at least one non-AP STA (e.g., STA1, STA2, STA3, and/or STA4) associated to the AP (e.g., AP1) will perform implicit subband switching. Alternatively, the AP (e.g., AP1) may send a notification frame to explicitly control whether the at least one non-AP STA (e.g., STA1, STA2, STA3, and/or STA4) associated to the AP (e.g., AP1) should stay on its current operation channel or switch to a new operation channel.

At step S1104, the AP (e.g., AP1) checks a status of a current operation channel of each of the at least one non-AP STA (e.g., STA1, STA2, STA3, and/or STA4) associated to the AP (e.g., AP1). At step S1106, the AP (e.g., AP1) determines whether the secondary channel only subband operation during interference on primary channel is better than spatial reuse with subband operation. If it is determined that the secondary channel only subband operation during interference on primary channel is better than spatial reuse with subband operation, the AP (e.g., AP1) may take actions (e.g., FES actions) for the secondary channel only subband operation during interference on primary channel (step S1108). If it is determined that the secondary channel only subband operation during interference on primary channel is not better than spatial reuse with subband operation, the AP (e.g., AP1) may take actions (e.g., FES actions) for the spatial reuse with subband operation (step S1110).

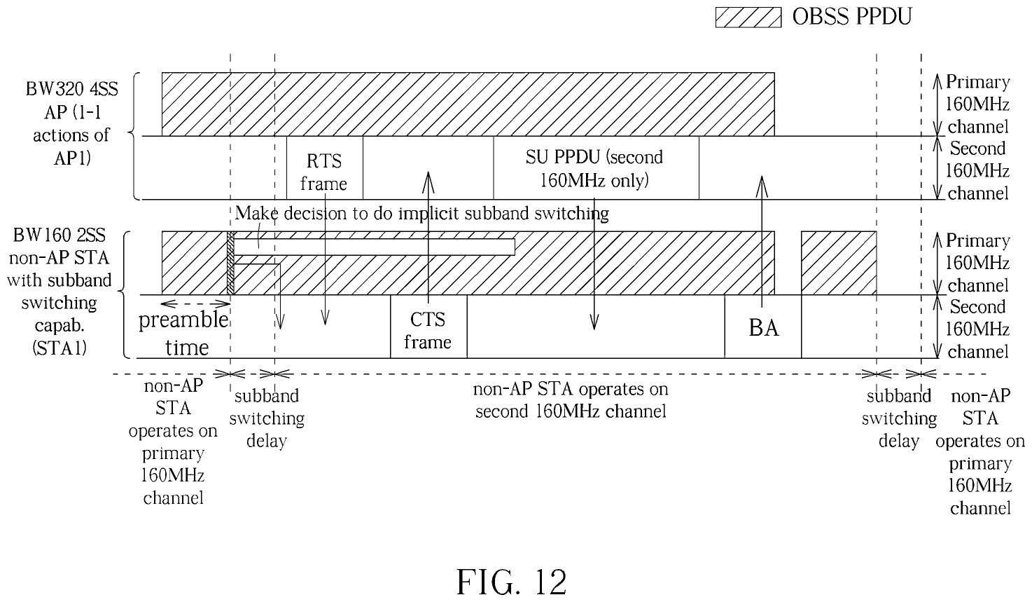

For example, AP's actions (e.g., FES actions) may be categorized into 1-1 actions, 2-1 actions, 2-2 actions, 3-1 actions, and 3-2 actions. In a case where there is only a single non-AP STA (e.g., STA1) associated to an AP (e.g., AP1), the AP (e.g., AP1) takes 1-1 actions for the secondary channel only subband operation during interference on primary channel, as illustrated in FIG. 12.

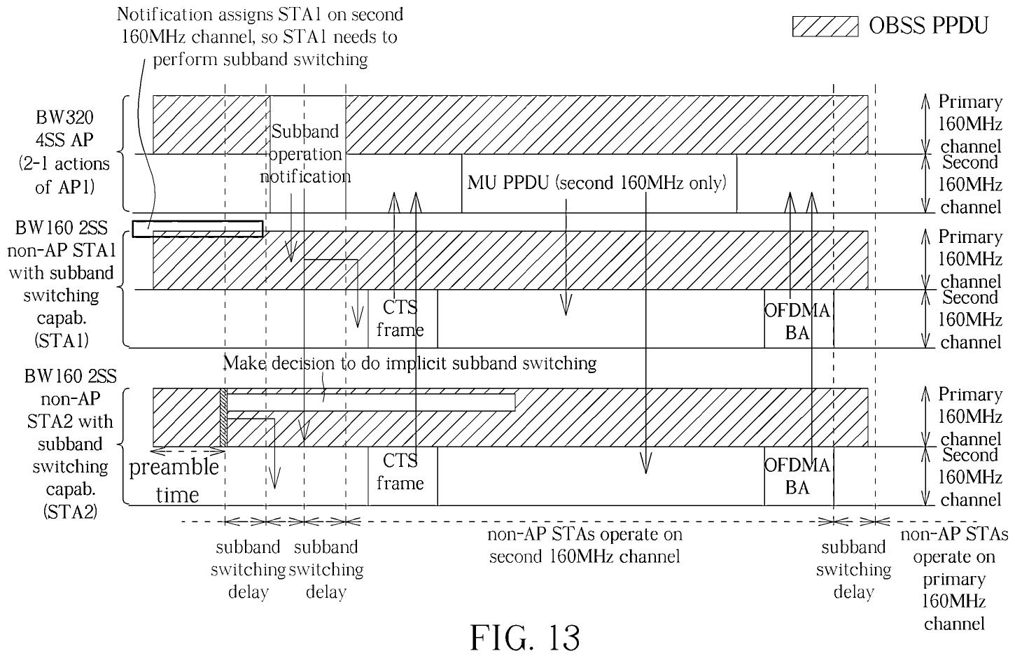

In a case where there are two non-AP STAs (e.g., STA1 and STA2) associated to an AP (e.g., AP1), the non-AP STA (STA1) performs implicit subband switching, and the non-AP STA (STA2) performs explicit subband switching, the AP (e.g., AP1) takes 2-1 actions for the secondary channel only subband operation during interference on primary channel, as illustrated in FIG. 13.

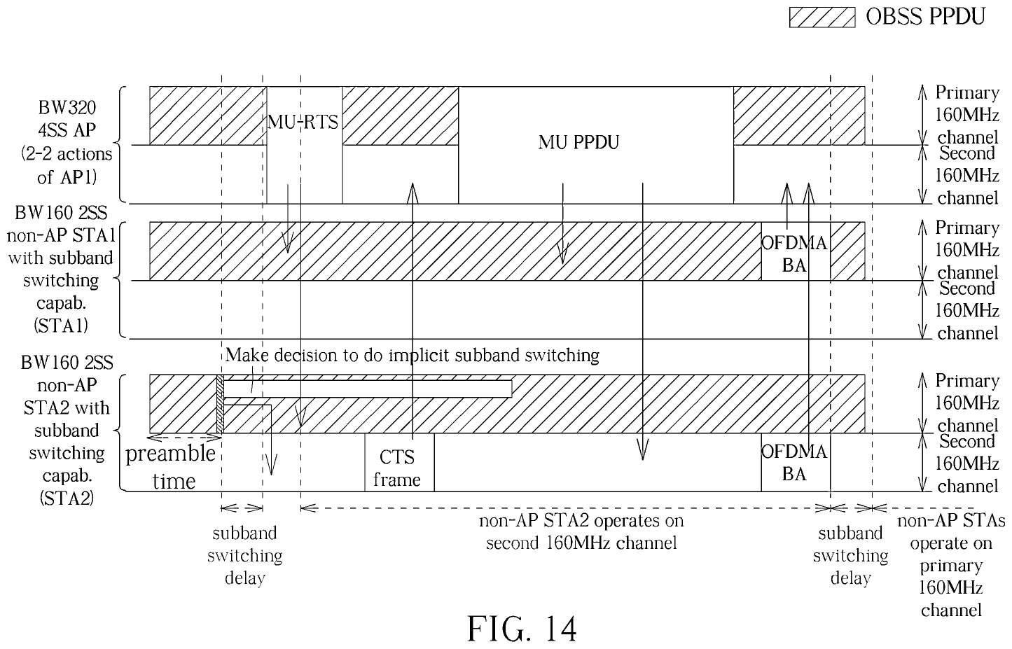

In a case where there are two non-AP STAs (e.g., STA1 and STA2) associated to an AP (e.g., AP1), the non-AP STA (STA1) stays on its current operation channel, and the non-AP STA (STA2) performs implicit subband switching, the AP (e.g., AP1) takes 2-2 actions for the spatial reuse with subband operation, as illustrated in FIG. 14.

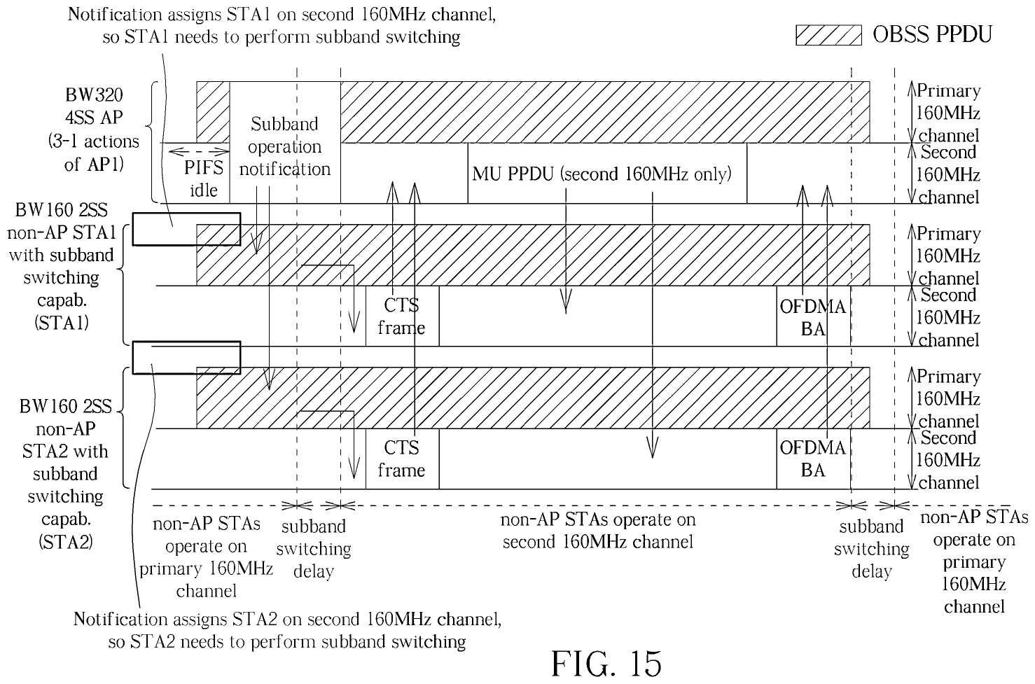

In a case where there are two non-AP STAs (e.g., STA1 and STA2) associated to an AP (e.g., AP1), the non-AP STA (STA1) performs explicit subband switching, and the non-AP STA (STA2) performs explicit subband switching, the AP (e.g., AP1) takes 3-1 actions for the secondary channel only subband operation during interference on primary channel, as illustrated in FIG. 15.

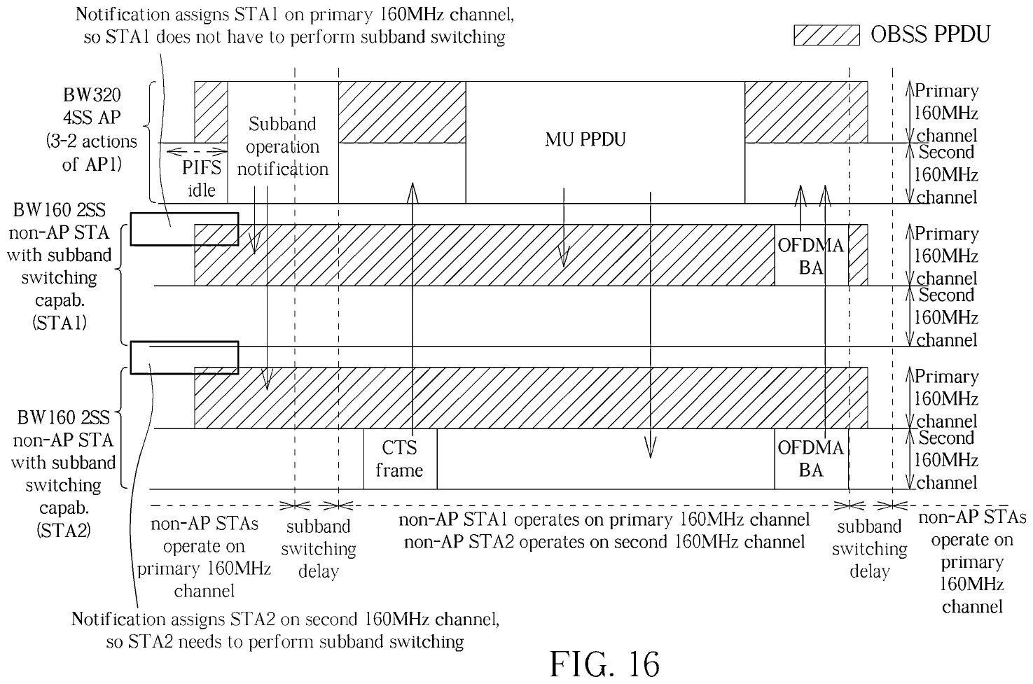

In a case where there are two non-AP STAs (e.g., STA1 and STA2) associated to an AP (e.g., AP1), the non-AP STA (STA1) stays on its current operation channel, and the non-AP STA (STA2) performs explicit subband switching, the AP (e.g., AP1) takes 3-2 actions for the spatial reuse with subband operation, as illustrated in FIG. 16.

It should be noted that the frequency hopping scenarios shown in FIGS. 2-10 and 12-16 are for illustrative purposes only, and are not meant to be limitations of the present invention. In practice, any WLAN system using the proposed frequency hopping scheme for co-channel interference avoidance falls within the scope of the present invention, where the proposed frequency hopping scheme may include implicit channel switching, explicit channel switching, implicit subband switching, explicit subband switching, or any combination thereof. In addition, the FES operation performed during a co-channel interference avoidance period may be DL SU, DL/UL OFDMA, or DL/UL MU-MIMO in OFDMA, depending upon actual application requirements.

For example, if there is only a single non-AP STA associated to an AP and the single non-AP STA performs subband switching to switch to a secondary 160 MHz channel, the AP may receive a CTS frame on the secondary 160 MHz channel, send an SU PPDU on the secondary 160 MHz channel, and receive a BA frame on the secondary 160 MHz channel during DL FES.

For example, if there is only a single non-AP STA associated to an AP and the single non-AP STA performs subband switching to switch to a secondary 160 MHz channel, the AP may receive a CTS frame on the secondary 160 MHz channel, send a trigger frame on the secondary 160 MHz channel, receive a TB PPDU on the secondary 160 MHz channel, and send a BA frame on the secondary 160 MHz channel during UL FES.

For example, if there are two non-AP STAs associated to an AP and each of the non-AP STAs performs subband switching to switch to a secondary 160 MHz channel, the AP may receive CTS frames on the secondary 160 MHz channel, send an MU PPDU on the secondary 160 MHz channel, and receive OFDMA BA frames on the secondary 160 MHz channel during DL FES.

For example, if there are two non-AP STAs associated to an AP, one non-AP STA stays on a primary 160 MHz channel, and the other non-AP STA switches to a secondary 160 MHz channel, the AP may receive a CTS frame on the secondary 160 MHz channel, send an MU PPDU on a BW320 operation channel, receive an OFDMA BA frame on the primary 160 MHz channel, and receive an OFDMA BA frame on the secondary 160 MHz channel during DL FES.

For example, if there are two non-AP STAs associated to an AP and each of the non-AP STAs performs subband switching to switch to a secondary 160 MHz channel, the AP may receive CTS frames on the secondary 160 MHz channel, send a trigger frame on the secondary 160 MHz channel, receive TB PPDUs on the secondary 160 MHz channel, and send an OFDMA BA frame on the secondary 160 MHz channel during UL FES.

For example, if there are two non-AP STAs associated to an AP, one non-AP STA stays on a primary 160 MHz channel, and the other non-AP STA switches to a secondary 160 MHz channel, the AP may receive a CTS frame on the secondary 160 MHz channel, send a trigger frame on a BW320 operation channel, receive a TB PPDU on the primary 160 MHz channel, receive a TB PPDU on the secondary 160 MHz channel, and send an OFDMA BA frame on the BW320 operation channel during UL FES.

For example, if there are multiple non-AP STAs associated to an AP and each of the non-AP STAs performs subband switching to switch to a 80 MHz channel within a secondary 160 MHz channel, the AP may receive CTS frames on 80 MHz channel(s) within the secondary 160 MHz channel, send an MU PPDU on the secondary 160 MHz channel, and receive OFDMA BA frames on 80 MHz channel (s) within the secondary 160 MHz channel during DL FES.

For example, if there are multiple non-AP STAs associated to an AP and the non-AP STAs include STA(s) staying on 80 MHz channel (s) within a primary 160 MHz channel and STA(s) switching to 80 MHz channel (s) within a secondary 160 MHz channel, the AP may receive CTS frame(s) on 80 MHz channel(s) within the secondary 160 MHz channel, send an MU PPDU on the BW320 operation channel, receive OFDMA BA frame (s) on 80 MHz channel(s) within the primary 160 MHz channel, and receive OFDMA BA frame (s) on 80 MHz channel (s) within the secondary 160 MHz channel during DL FES.

For example, if there are multiple non-AP STAs associated to an AP and each of the non-AP STAs performs subband switching to switch to a 80 MHz channel within a secondary 160 MHz channel, the AP may receive CTS frames on 80 MHz channel(s) within the secondary 160 MHz channel, send a trigger frame on the secondary 160 MHz channel, receive TB PPDUs on 80 MHz channel(s) within the secondary 160 MHz channel, and send an OFDMA BA frame on the secondary 160 MHz channel during UL FES.

For example, if there are multiple non-AP STAs associated to an AP and the non-AP STAs include STA(s) staying on 80 MHz channel (s) within a primary 160 MHz channel and STA(s) switching to 80 MHz channel (s) within a secondary 160 MHz channel, the AP may receive CTS frame(s) on 80 MHz channel(s) within the secondary 160 MHz channel, send a trigger frame on a BW320 operation channel, receive TB PPDU(s) on 80 MHz channel(s) within the primary 160 MHz channel, receive TB PPDU(s) on 80 MHz channel(s) within the secondary 160 MHz channel, and send an OFDMA BA frame on the BW320 operation channel during UL FES.

Furthermore, regarding the implicit/explicit subband switching scenario, an AP may operate on a wide-BW operation channel consisting of one primary channel and more than one secondary channel.

In above embodiments, a Wi-Fi device (e.g., an AP or a non-AP STA) may start to switch back to its original operation channel at an end time of a switching period (e.g., an implicit channel switching period, an explicit channel switching period, an implicit subband switching period, or an explicit subband switching period). It should be noted that the definition of the switching period may vary, depending upon actual design considerations. Hence, the present invention has no limitations on how to determine the switching period. For example, the switching period may be determined based on a remaining OBSS PPDU period and an expected OBSS BA period. For another example, the switching period may be determined based on a remaining OBSS PPDU period. For yet another example, the switching period may be determined based on a NAV period from an OBSS RTS frame. However, these are for illustrative purposes only, and are not meant to be limitations of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless local area network (WLAN) system comprising:
a first Wi-Fi device; and
at least one second Wi-Fi device;
when the first Wi-Fi device and the at least one second Wi-Fi device receive an interference signal that occupies a current operation channel of the first Wi-Fi device and a current operation channel of the at least one second Wi-Fi device, the first Wi-Fi device performs channel switching upon the current operation channel of the first Wi-Fi device, and the at least one second Wi-Fi device performs channel switching upon the current operation channel of the at least one second Wi-Fi device.

2. The WLAN system of claim 1, wherein the first Wi-Fi device is an access point (AP), and the at least one second Wi-Fi device comprises a non-AP station (STA) associated to the AP.

3. The WLAN system of claim 2, wherein the first Wi-Fi device and the at least one second Wi-Fi device operate in a same basic service set (BSS), and the interference signal is an overlapping BSS (OBSS) physical layer protocol data unit (PPDU).

4. The WLAN system of claim 3, wherein in response to at least one parameter included in the OBSS PPDU, the first Wi-Fi device performs the channel switching upon the current operation channel of the first Wi-Fi device, and the at least one second Wi-Fi device performs the channel switching upon the current operation channel of the at least one second Wi-Fi device; and the at least one parameter is pre-negotiated between the first Wi-Fi device and the at least one second Wi-Fi device before the OBSS PPDU is received by the first Wi-Fi device and the at least one second Wi-Fi device.

5. The WLAN system of claim 1, wherein in response to the interference signal, the first Wi-Fi device sends a notification frame to the at least one second Wi-Fi device; and in response to the notification frame, the at least one second Wi-Fi device performs the channel switching upon the current operation channel of the at least one second Wi-Fi device.

6. The WLAN system of claim 5, wherein the first Wi-Fi device is an access point (AP), and the at least one second Wi-Fi device comprises a non-AP station (STA) associated to the AP.

7. The WLAN system of claim 6, wherein the first Wi-Fi device provides negotiation suggestion to the at least one second Wi-Fi device, for suggesting actions of the channel switching performed upon the current operation channel of the at least one second Wi-Fi device.

8. The WLAN system of claim 5, wherein the first Wi-Fi device is a sharing access point (AP) of a multi-AP system, the at least one second Wi-Fi device comprises a shared AP of the multi-AP system, and the notification frame is a multi-AP trigger frame.

9. The WLAN system of claim 1, wherein the first Wi-Fi device further performs another channel switching to switch back to an original operation channel on which the first Wi-Fi device operates at the time the interference signal is received, and the at least one second Wi-Fi device further performs another channel switching to switch back to an original operation channel on which the at least one second Wi-Fi device operates at the time the interference signal is received.

10. A wireless local area network (WLAN) system comprising:
a first Wi-Fi device; and
at least one second Wi-Fi device;
when the first Wi-Fi device and the at least one second Wi-Fi device receive an interference signal that occupies a partial operation channel included in a current operation channel of the first Wi-Fi device and a current operation channel of the at least one second Wi-Fi device, the at least one second Wi-Fi device performs subchannel switching upon the current operation channel of the at least one second Wi-Fi device to switch to a new operation channel which is included in another partial operation channel in the current operation channel of the first Wi-Fi device.

11. The WLAN system of claim 10, wherein the first Wi-Fi device is an access point (AP), the at least one second Wi-Fi device comprises a non-AP station (STA) associated to the AP, the partial operation channel is a primary channel, and the another partial operation channel is a secondary channel.

12. The WLAN system of claim 11, wherein the first Wi-Fi device and the at least one second Wi-Fi device operate in a same basic service set (BSS), and the interference signal is an overlapping BSS (OBSS) physical layer protocol data unit (PPDU).

13. The WLAN system of claim 12, wherein in response to at least one parameter included in the OBSS PPDU, the at least one second Wi-Fi device performs the subband switching upon the current operation channel of the at least one second Wi-Fi device; and the at least one parameter is pre-negotiated between the first Wi-Fi device and the at least one second Wi-Fi device before the OBSS PPDU is received by the first Wi-Fi device and the at least one second Wi-Fi device.

14. The WLAN system of claim 10, wherein in response to the interference signal, the first Wi-Fi device sends a notification frame to the at least one second Wi-Fi device; and in response to the notification frame, the at least one second Wi-Fi device performs the subband switching upon the current operation channel of the at least one second Wi-Fi device.

15. The WLAN system of claim 14, wherein the first Wi-Fi device is an access point (AP), and the at least one second Wi-Fi device comprises a non-AP station (STA) associated to the AP.

16. The WLAN system of claim 15, wherein the first Wi-Fi device provides negotiation suggestion to the at least one second Wi-Fi device, for suggesting actions of the subband switching performed upon the current operation channel of the second Wi-Fi device.

17. The WLAN system of claim 15, wherein a response frame generated in response to the notification frame is sent on the new operation channel only.

18. The WLAN system of claim 15, wherein in response to the interference signal, each of the at least one second Wi-Fi device performs subchannel switching.

19. The WLAN system of claim 15, wherein in response to the interference signal, the first Wi-Fi device checks a status of a current operation channel of each of the at least one second Wi-Fi device to determine actions of the first Wi-Fi device.

20. The WLAN system of claim 10, wherein the at least one second Wi-Fi device further performs another subband switching to switch back to an original operation channel on which the at least one second Wi-Fi device operates at the time the interference signal is received.
